(19) United States
(12) Patent Application Publication
(10) Pub. No.: US 2014/0084707 A1
(43) Pub. Date: Mar. 27, 2014

(54) POWER SUPPLY CONTROL DEVICE WITH USER IDENTIFYING FUNCTION AND CONTROL METHOD

(71) Applicant: HUAN-SHENG CHEN, Tu-Cheng (TW)

(72) Inventor: HUAN-SHENG CHEN, Tu-Cheng (TW)

(21) Appl. No.: 13/664,443

(22) Filed: Oct. 31, 2012

(30) Foreign Application Priority Data
Sep. 27, 2012 (TW) 101135462

(51) Int. Cl. H01H 47/20

(52) U.S. Cl. 307/117

(57) ABSTRACT

A method for controlling connection or disconnection between a load and a power source via a power supply control device with user identifying function is provided. The method includes sensing an encoded signal transmitted by a second antenna of a handset device by a first antenna; decoding the encoded signal by a decoding unit when the decoder outputs a different voltage; and controlling a switching unit to connect the power source to or disconnect the power source from the load, and when the decoding unit successfully decodes the encoded signal. The power supply control device is also provided.

### BACKGROUND

1. Technical Field

The present disclosure relates to power supply control devices and controlling methods, and particularly to a power supply control device with user identifying function for controlling connection or disconnection between a load and a power source, and a control method employed by the power supply control device.

2. Description of Related Art

A conventional power supply control apparatus includes a control module and the electrical outlet. The control module is connected to an external electronic device through an interface, and controls the connection of the electrical outlet via wireless or wired manner, thereby controlling the external electronic device to work. However, the power control device can be controlled by anyone operating the power control device, which reduces the safety of the power supply control.

Therefore, it is desirable to provide a power supply control device with user identifying function and control method which can overcome the above-mentioned shortcomings.

### BRIEF DESCRIPTION OF THE DRAWINGS

FIG. 1 is a schematic diagram of a power supply control device with user identifying function, according to a first embodiment.

FIG. 2 is a flowchart showing a control method for identifying user by the power control device of FIG. 1.

FIG. 3 is a schematic diagram of a power supply control device with user identifying function, according to a second embodiment.

### DETAILED DESCRIPTION

Embodiments of the disclosure will be described with reference to the accompanying drawings.

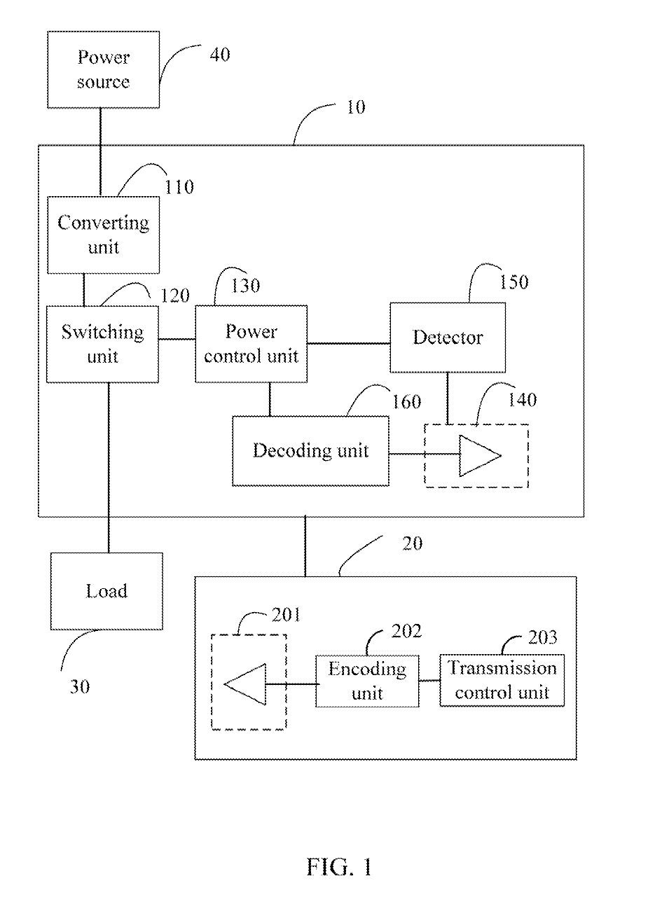

Referring to FIG. 1, a schematic diagram of a power supply control device 10 with user identifying function is provided. The power supply control device 10 controls the connection between a load 30 and a power source 40. The power supply control device 10 is connected to a handset device 20.

The handset device 20 includes a second antenna 201, an encoding unit 202, and a transmission control unit 203. The handset device 20 is used by a user within a predetermined range of the power supply control device 10. The encoding unit 202 generates an encoded signal. The encoded signal includes user information. The transmission control unit 203 transmits the encoded signal through the second antenna 201. The transmission control unit 203 can use near field communication (NFC) technology to transmit the encoded signal through the second antenna 201.

The power supply control device 10 includes a converting unit 110, a switching unit 120, a power control unit 130, a first antenna 140, a detector 150, and a decoding unit 160.

The converting unit 110 is connected with the power source 40, converts alternating current from the power source 40 into direct current.

The switching unit 120 is connected between the converting unit 110 and the load 30. The switching unit 140 controls the connection or disconnection of the converting unit 110 from the load 30. The switching unit 140 can be a relay.

The first antenna 140 senses and receives the encoded signal transmitted by the second antenna 201 of the handset device 20.

The detector 150 outputs a first voltage when the encoded signal from the second antenna 201 is sensed by the first antenna 140, and outputs a second voltage when the encoded signal from the second antenna 201 is sensed by the first antenna 140. For example, the detector 150 outputs a high level signal when the encoded signal from the second antenna 201 is sensed by the first antenna 140, and outputs a low level signal when the encoded signal from the second antenna 201 is not sensed by the first antenna 140. The detector 150 outputs the low level signal when the encoded signal from the second antenna 201 is sensed by the first antenna 140, and outputs the high level signal when the encoded signal from the second antenna 201 is not sensed by the first antenna 140.

The decoding unit 160 decodes the encoded signal to obtain the user information.

The power control unit 130 is connected with the first antenna 140, the switching unit 120, the detector 150, and the decoding unit 160. The power control unit 130 determines whether the decoder 150 outputs a different voltage according to the first voltage and the second voltage. Supposing the detector 150 outputs a high level signal when the encoded signal from the second antenna 201 is sensed by the first antenna 140 and outputs a low level signal when the encoded signal from the second antenna 201 is not sensed by the first antenna 140, the power control unit 130 determines the decoder 150 outputs the different voltage when receiving the high level signal. Supposing the detector 150 outputs the low level signal when the encoded signal from the second antenna 201 is sensed by the first antenna 140, and outputs the high level signal when the encoded signal from the second antenna 201 is not sensed by the first antenna 140, the power control unit 130 determines the decoder 150 outputs the different voltage when receiving the low level signal.

The power control unit 130 determines whether the decoding unit 160 successfully decodes the encoded signal when the decoder 150 outputs the different voltage. When the decoding unit 160 successfully decodes the encoded signal, the power control unit 130 controls the switching unit 120 to connect or disconnect the converting unit 110 from the load 30. Method of determining whether the decoding unit 160 successfully decodes the encoded signal can be referenced by existing knowledge, for example, determining whether decoded data is same as a predetermined rule.

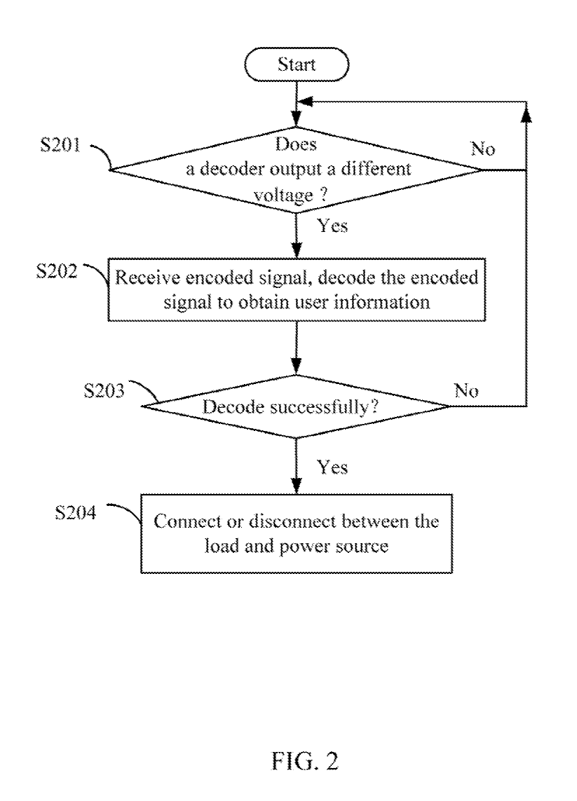

FIG. 2 is a schematic diagram of a power supply control device with user identifying function.

In step S201, the power control unit 130 determines whether the decoder 150 output the different voltage. If yes, the procedure goes to step S202, otherwise, the procedure repeats step S201.

In step S202, the decoding unit 160 receives the encoded signal, decodes the encoded signal to obtain the user information.

In step S203, the power control unit 130 determines whether the decoding unit 160 successfully decodes the encoded signal. If yes, the procedure goes to step S204, otherwise, the procedure goes to step S201.

In step S204, the power control unit 130 controls the switching unit 120 to connect or disconnect the converting unit 110 from the load 30, thus connect or disconnect the load 30 from the external power source 40.

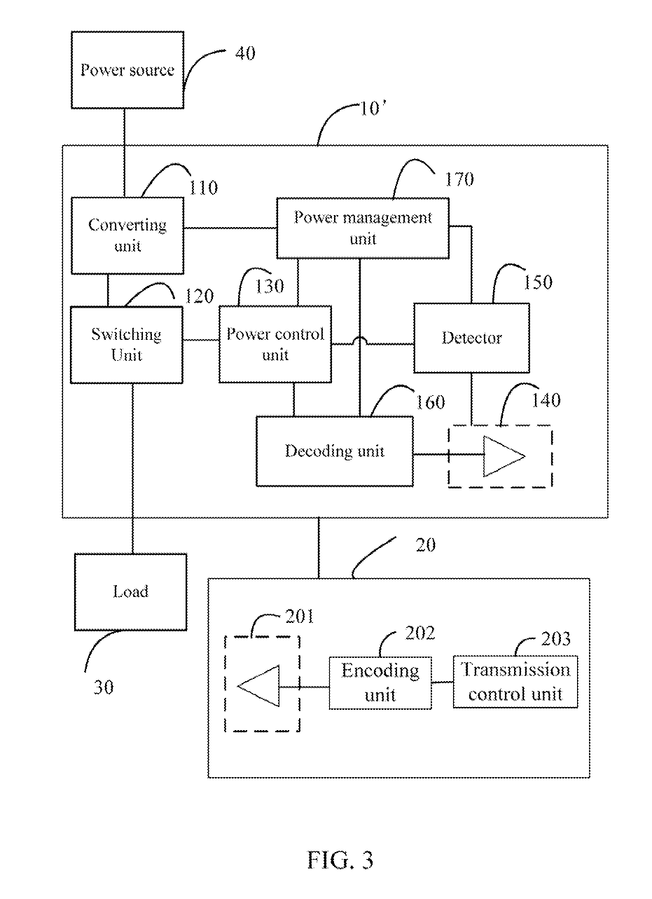

FIG. 3 is a schematic diagram of a power supply control device with user identifying function, according to a second embodiment. Compared with FIG. 1, the power control device 10′ further includes a power management unit 170, to supply the direct current converted by the converting unit 110 to the switching unit 120, the power control unit 120, the first antenna 140, the detector 150 and the decoding unit 160, to make the switching unit 120, the power control unit 120, the first antenna 140, the detector 150 and the decoding unit 160 work.

Though the method above, when the handset device 20 is used within the predetermined range of the power control device 10/10′, the power control device 10/10′ senses and obtains the encoded signal including the user information, decodes the encoded signal to obtain the user information, control the connection and disconnection between the load 30 and the external power source 40 when the encoded signal is successfully decoded, that is, only when using the handset device 20, the power control device 10/10′ control the connection and disconnection between the load 30 and the external power source 40, this increases safety of power supply control.

Particular embodiments are shown here and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A power supply control device with user identifying function, connected between a load and an power source for controlling connection or disconnection between the load and the power source, comprising:
a first antenna, to sense an encoded signal from a second antenna of a handset device;
a detector, to output a first voltage when the encoded signal from the second antenna is sensed by the first antenna and a second voltage when the encoded signal from the second antenna is not sensed by the first antenna;
a decoding unit, to decode the encoded signal when the detector outputs a different voltage according to the first voltage and the second voltage;
a converting unit, connected with the power source, to convert alternating current from the power source into direct current;
a switching unit connected between the converting unit and the load, to control connection between the converting unit and the load; and
a power control unit, connected with the first antenna, the switching unit, the detector and the decoder, to control the switching unit to connect the converting unit to or disconnect the converting unit from the load, and when the decoding unit successfully decodes the encoded signal, thereby controlling connection or disconnection between the load and the power source.

2. The power supply control device according to claim 1, wherein the switching unit is a relay.

3. The power supply control device according to claim 1, wherein the handset device comprises an encoding unit to generate an encoded signal including the user information, and a transmission control unit to transmit the encoded signal by the second antenna.

4. The power supply control device according to claim 3, wherein the transmission control unit uses near field communication (NFC) technology to transmit the encoded signal through the second antenna.

5. The power supply control device according to claim 1, wherein the detector outputs a high level signal when the encoded signal from the second antenna is sensed by the first antenna, and outputs a low level signal when the encoded signal from the second antenna is not sensed by the first antenna, that is, the first voltage is the high level signal, and the second voltage is the low level signal.

6. The power supply control device according to claim 5, wherein the decoder outputs the different voltage is determined when the detector outputs the high level signal.

7. The power supply control device according to claim 1, wherein the detector outputs a low level signal when the second antenna is sensed by the first antenna, and outputs a high level signal when the second antenna is not sensed by the first antenna, that is, the first voltage is the low level signal, and the second voltage is the high level signal.

8. The power supply control device according to claim 7, wherein the decoder outputs the different voltage is determined when the detector outputs low level signal.

9. The power supply control device according to claim 1, further comprising a power management unit, to supply the direct current converted by the converting unit to the switching unit, the power control unit, the first antenna, the detector and the decoding unit, to make the switching unit, the power control unit, the first antenna, the detector and the decoding unit work.

10. A method for controlling connection or disconnection between a load and a power source via a power supply control device with user identifying function, comprising:
sensing an encoded signal transmitted by a second antenna of a handset device by a first antenna;
decoding the encoded signal by a decoding unit when the decoder outputs a different voltage; and
controlling a switching unit to connect the power source to or disconnect the power source from the load, and when the decoding unit successfully decodes the encoded signal.

11. The method according to claim 10, wherein the switching unit is a relay.

12. The method according to claim 10, further comprising outputting a high level signal by the decoder when the encoded signal transmitted by the second antenna is sensed by the first antenna, and outputting a low level signal by the decoder when the encoded signal transmitted by the second antenna is not sensed by the first antenna.

13. The method according to claim 12, further comprising determining whether a decoder outputs the different voltage by determining whether outputting the high level signal by the decoder.

14. The method according to claim 10, further comprising outputting a low level signal by the decoder when the encoded signal transmitted by the second antenna is sensed by the first antenna, and outputting a high level signal by the decoder when the encoded signal transmitted by the second antenna is not sensed by the first antenna.

15. The method according to claim 14, further comprising determining whether a decoder outputs the different voltage by determining whether outputting the low level signal by the decoder.

16. The method according to claim 14, further comprising: converting alternating current from the power source into direct current; and supplying the direct current to the switching unit, the first antenna, the detector and the decoding unit, to make the switching unit, the first antenna, the detector and the decoding unit work.
